(19) United States
(12) Patent Application Publication
(10) Pub. No.: US 2006/0231363 A1
(43) Pub. Date: Oct. 19, 2006

(54) Damping Device

(76) Inventor: Masaaki Chiba, Saitama-ken (JP)

Correspondence Address: ARENT FOX PLLC, 1050 CONNECTICUT AVENUE, N.W., SUITE 400, WASHINGTON, DC, 20036, US

(21) Appl. No.: 10/538,408

(22) PCT Filed: Dec. 12, 2003
(86) PCT No.: PCT/JP03/15932

§ 371 Date: Oct. 24, 2005

(30) Foreign Application Priority Data
Dec. 12, 2002 (JP) 2002-360805
Dec. 1, 2003 (JP) 20023-401451

(51) Int. Cl. F16F 11/00

(52) U.S. Cl. 188/381

(57) ABSTRACT

A damping device for use in industrial machinery and tools comprising a housing (102, 602) and a flange member (104, 604) arranged in the housing, wherein at least portions of the flange member apart from the center thereof are composed of an elastic material and inclined with respect to the axial direction or the radial direction of the rotational axis and the flange member is so designed that the peripheral face thereof is brought into contact with the inner wall of the housing. This device can generate a damping force which may be drastically changed depending on the operating directions and thus permits stable damping. In the direct acting type one, the flange member (104) is tapered on the corresponding both faces towards the periphery thereof, it never requires the formation of any space for allowing any deformation on the largely deformed side, the device can thus be miniaturized in the axial direction and permits the reduction of the weight thereof and it can operate even in response to motions having a fine amplitude to thus show excellent damping characteristics. In the rotary type one, the flange member (604) comprises an engaging member capable of being engaged with a shaft body (603) and is provided with projected or convex portions (604a) on its outer periphery. The projected portions are inclined towards the radial direction of the rotating shaft to thus efficiently show their excellent differential rotation-damping characteristics and the damping characteristics may arbitrarily be controlled. These damping devices can be used as dampers for suspensions of bicycles, rotary dampers applied to chairs and dampers for opening and closing doors.

### TECHNICAL FIELD

The present invention relates to a damping device or a damper and, in particular, to a damping device which is used in, for instance, industrial machinery and tools and which can generate a damping force when there is a differential motion between two members and can generate a substantially different damping force depending on the operating direction thereof. More particularly, the present invention relates to a damping device which can diminish, in particular, a linear reciprocating differential motion and a rotational differential motion.

### BACKGROUND ART

As damping devices, there has conventionally been known a so-called direct acting type oil damping (viscous damping) device which makes use of the fluid resistance of, for instance, oil such as a shock absorber used in, for instance, automobiles. The viscous damping device of this type suffers from various problems specified below:

(1) The damping device of this type has a complicated structure and the production cost thereof is thus increased since it is necessary to form flow paths within a housing; and

(2) The damping device of this type requires the use of a large number of built-in parts for constituting such flow paths and for accommodating a fluid and the overall weight thereof would correspondingly be increased.

In consideration of the foregoing circumstances, there has been proposed a damping device which makes use of the frictional force as a damping device which permits the solution of the foregoing problems of the viscous damping device, the simplification of the structure thereof and the reduction of the weight thereof (see, for instance, TOKUHYO Hei 11-511229).

In the damping device disclosed in the gazette, as shown in, for instance, FIG. 1 attached to this gazetted patent, a backing plate 26 serving as a supporting plate is pressed against only one face of an elastomer disk 22 serving as a flange 23 and a plurality of such disks each having the backing plate are arranged in layers to thus control the deformation of the flange in one direction (the direction of contraction in FIG. 1), while the flange can freely be deformed in the other direction (in the direction of elongation or expansion in FIG. 1). This accordingly results in a difference between the frictional forces generated in every directions, concerning the friction between the inner wall of a housing and the periphery of the flange 23.

However, the damping device disclosed in the foregoing gazetted patent likewise suffers from the following problems:

(1) The friction-generating mechanism according to this technique is based on the contact, under pressure, between the inner wall of the housing and the periphery of the flange 23 and the ability of the flange to be easily deformed is simply controlled by the action of the supporting plate to thus generate a difference in the frictional force depending on the operating direction. Therefore, the highest pressure contact force acts between the inner wall of the housing and the periphery of the flange 23 at their stationary state and accordingly, the static friction is likewise high. Accordingly, when using this friction-generating mechanism, in particular, as a cylindrical damping device (a shock absorber), the mounting ability thereof is insufficient since the mechanism is hardly rotated in its rotational direction.

(2) In this mechanism, the damping force is controlled on the basis of the easy deformability of the flange 23 and therefore, a space for tolerating or allowing such deformation must be provided on the side wherein the flange is largely deformed.

(3) In this mechanism, it is essential to prepare the supporting plate from a material which is sufficiently strong to such an extent that it can withstand the deformational load. For this reason, it is usually made of a steel plate. However, it is too heavy and it is quite difficult to make the size thereof in its axial direction compact.

(4) If the reciprocating motion inputted is one having a very small amplitude falling within the range of deformation allowed for the flange 23 to undergo, there is not observed any relative friction movement between the inner wall of the housing and the periphery of the flange 23 in the direction along which the flange is so designed as to be freely deformed and therefore, any damping force is not generated in such a direction. The static friction generated between these members should be reduced in order to operate the device even when the amplitude is quite small and therefore, the contact pressure generated between the inner wall of the housing and the periphery of the flange 23 should in turn be reduced by the miniaturization of the flange 23. In this case, however, the kinetic friction acting between them at a large amplitude is naturally reduced and accordingly, it is quite difficult to establish a well-balanced relationship between the friction generated when amplitudes are quite small and the friction generated when amplitudes are very large.

There have also been known other damping devices such as viscous oil-type rotary damping devices which make use of the fluid friction of, for instance, viscous oil materials. These oil-type rotary damping devices have been used in a wide variety of fields such as door closers, bearing portions for suspension and/or cover closing-opening mechanisms, but they also suffer from the problems listed below:

(1) The damping device of this type has a complicated structure and the production cost thereof is thus increased since it is necessary to form flow paths within a housing.

(2) The damping device of this type requires the use of a large number of built-in parts for constituting such flow paths and for accommodating a fluid and the overall weight thereof would correspondingly be increased.

(3) These devices make use of fluids. Consequently, the devices should be provided with, for instance, liquid-tight and/or sliding or rotational seals and this accordingly requires the establishment of a quite high dimensional precision of the device and this in turn leads to an increased production cost.

There has been proposed a rotary damper which makes use of the frictional force in order to solve the foregoing problems associated with the oil-type rotary damping devices (see, for instance, Japanese Un-Examined Patent Publication 2002-193012). As will be clear from, for instance, the description of the gazetted document and FIG. 1 attached thereto, the rotary damper disclosed in this patent is one provided with a main case body 20 and a shaft body 30. This friction type damper is so designed that the main case body 20 and the shaft body 30 are so arranged as to bring the inner peripheral face of the main case body into close contact with the outer peripheral face of the shaft body and that a plurality of depressed portions are arranged on either the inner peripheral face or the outer peripheral face so as to only partially bring one of them into contact with the other, for the stabilization of the braking (damping force) against the rotational motion of the main case body.

The rotary damper disclosed in the foregoing gazetted patent likewise suffers from the following problems:

(1) This damper is so designed that it is simply provided with contact areas for damping and therefore, the damper can never have damping characteristics having directional properties required when the main case body is in its rotating condition.

(2) This damper is so designed that it is simply provided with depressed portions formed on either the inner peripheral face of the main case body or the outer peripheral face of the shaft body to reduce the contact area between the inner peripheral face and the outer peripheral face to thus stabilize the damping force. Accordingly, this damper can control the damping force only through the adjustment of the magnitude of the contact area between these members. Therefore, the damping force of the device would be determined upon the assemblage of the damper and the damper never permits the control of the damping force thereof during the practical use of the same.

### DISCLOSURE OF THE INVENTION

It is in general an object of the present invention to solve the foregoing problems associated with the conventional techniques and more specifically to provide a damping device or damper which has a simple structure, can easily be secured to other devices, has a light weight and can be produced at low cost and further which shows excellent damping characteristics capable of being widely changed depending on the relative differential directions. In particular, it is an object of the present invention to provide a damping device showing damping characteristics, which never requires any space for allowing deformation on the side in which the deformation is large, permits the miniaturization of the device in the axial direction and the reduction of the weight thereof, and can operate in response to even a quite small amplitude, as well as a damping device which can efficiently show the damping of rotational differential motions and which can arbitrarily control the damping characteristics.

The damping device according to the present invention comprises a housing and a flange member for damping arranged in the housing, wherein at least portions of this flange member apart from the center thereof are composed of an elastic material and inclined with respect to the axial direction or the radial direction of the rotational axis and wherein the flange member is so designed that the peripheral face thereof is brought into contact with the inner wall of the housing at an angle. Thus, there can be provided damping device which 4 has a simple structure, can easily be secured to other devices, has a light weight and can be produced at low cost and further which shows excellent damping characteristics capable of being widely changed depending on the relative differential directions.

The damping device according to the first embodiment of the present invention is a direct acting type one, it is so designed that it comprises a housing, a piston rod capable of undergoing reciprocating motions within the housing and a flange member for damping consisting of an elastic material and fitted to this piston rod, that the flange member is tapered towards the peripheral edges on its both sides opposed to one another and that the peripheral face of the flange member is thus pressed against the inner wall of the housing.

For this reason, the direct acting damping device is so designed that the inner wall of the housing is pressed against or engages with the peripheral face or the end face of the flange member, at the static state in a press contact condition and preferably in a slight press contact state. Therefore, the flange member preferably has an outer diameter which permits the establishment of such a press contact state.

The foregoing flange member is characterized in that a part thereof apart from its center is formed into a unidirectionally inclined shape.

In the foregoing direct acting type damping device, the flange member is secured to the piston rod in such a manner that, when the piston rod at its stationary position moves within the housing along and towards the direction A or towards one end of the axial direction, the peripheral face of the flange member is stopped with respect to the inner wall face of the housing due to the action of the frictional force generated between these faces to thus inhibit the movement thereof towards the direction A and to thus cause desired damping. The movement of the piston rod may further strongly press the peripheral face of the flange member against the inner wall face of the housing to thus increase the press contact force acting between them. Therefore, a stronger frictional force is correspondingly generated and as a result, effective damping can be ensured. In this respect, the term “direction A” means, for instance, the direction of contraction (contracting direction) due to the movement of the piston rod.

Moreover, the foregoing flange member is fitted to the piston rod in such a manner that, when the piston rod at its static state moves within the housing along and towards the direction B or the end of the axial direction opposite to the direction A, any press contact force is not generated (preferably, almost no press contact force is generated) due to any deflection of this flange member and any frictional force and in its turn any damping is not generated (preferably, such a frictional force or damping is scarcely generated).

Further, at least the peripheral face of the foregoing flange member may be produced from a self-lubricating rubber material.

The direct acting type damping device according to the present invention which has the structure specified above would permits the achievement of the following effects, or the efficient damping and the stable braking actions.

More specifically, the device at its static state does not generate any substantial frictional force, it may be designed so as to undergo free rotation and therefore, it can, for instance, effectively be fitted to other devices. In addition, it never requires any space for allowing deformation, unlike the conventional techniques. Further, the device of the present invention likewise never requires the use of any supporting plate used in the conventional technique. Therefore, this would permit the miniaturization of the device in the axial direction and in its turn the substantial reduction of the weight thereof. In this connection, a washer may be used, and the washer may be prepared from, for instance, a plastic material since it does not necessarily receive any load. In addition, the static friction is not high in this device and therefore, the device can operate in response even to a very small amplitude and may accordingly show damping characteristics considerably different depending on the operational directions.

The foregoing direct acting type damping device can be attached to a variety of industrial machinery and tools and it is, for instance, useful as the front suspension for bicycles.

Moreover, the damping device according to a second embodiment of the present invention is a rotary damping device. More specifically, this rotary damping device comprises a housing secured to one of two members and a flange member for damping which is so arranged that it is rotatable within the housing and has a member capable of being engaged with a shaft body fixed to the other member so that the differential rotary movements of these two members can be attenuated, wherein the flange member comprises an engaging member capable of being engaged with the shaft body, it is provided with convex or projected portions made of an elastic material on the outer periphery thereof, the convex portions are so designed that they are inclined with respect to the radial direction of the rotary shaft and pressed against the inner wall face of the housing. As has been described above, the convex portions of the flange member are so designed that they are inclined with respect to the radial direction of the rotary shaft and the outer peripheral faces (peripheral faces) of the tips of these convex portions are pressed against the inner wall face of the housing or the peripheral faces thereof are in a press contact state and preferably in a press contact state to some extent. Accordingly, the device efficiently permits the desired damping of the differential rotary movements between the housing and the flange member or the differential rotary movements observed between one member and another member, when the housing is rotated relative to the flange member (or shaft body).

The foregoing flange member is characterized in that the engaging member and the convex portions are integrally molded.

The flange member is also characterized in that at least the convex portions thereof are made of a self-lubricating rubber material.

The device according to this embodiment is characterized in that the housing and the flange member are so arranged that rotational resistance is generated when the housing rotates relative to the flange member in the direction opposite to the radial direction of the inclined convex portions formed on the flange member to thus damp the differential rotary movements generated between the housing and the flange member.

As has been discussed above, when the housing rotates relative to the flange member in the direction opposite to the radial direction of the convex portions formed on the flange member, the outer peripheral faces of the tips of these convex portions are more strongly pressed against the inner wall face of the housing, any force is thus applied to the convex portions, in the direction along which the convex portions are compressed, by the inner wall face of the housing which is in a press contact state with the convex portions so as to generate higher rotational resistance. Thus, the device efficiently permits the desired damping of the differential rotary movements between the housing and the flange member or the differential rotary movements observed between one member and another member.

The device according to this embodiment is likewise characterized in that the housing and the flange member are so arranged as to generate rotational resistance lower than that generated in the direction opposite to the radial direction of the inclined convex portions formed on the flange member when the housing rotates relative to the flange member in the direction identical to this radial direction.

In the rotary type damping device of the present invention, at least the tips of the convex portions may be formed on the flange member such that they are inclined with respect to the axial direction. Thus, a difference in the damping can be generated, which may vary depending on the direct acting directions.

The foregoing rotary type damping device is characterized in that it is secured to a member for suspension wherein the foregoing two members are a main body of a bicycle and rear wheel-supporting member (such as a rear arm or a swing arm including brackets and/or links attached thereto). In this respect, it is a matter of course that these two members are interchangeable. Alternatively, it is sufficient that the device of the invention may function as a damping device in a suspension mechanism and therefore, it may be attached to the mechanism through, for instance, a link arm as a member different from the spring member thereof.

The foregoing rotary type damping device is also characterized in that it is attached to the rotating mechanism for an opening and closing member (such as that for doors, covers or the like).

The rotary type damping device according to the present invention would permit efficient attenuation and damping because of the structure discussed above and accordingly, it shows the following effects:

More specifically, the device can ensure strong rotational damping between the flange member rotating in response to the rotation of the shaft body and the housing and the damping characteristics thereof can arbitrarily be controlled. Moreover, the damping device can be miniaturized, the weight thereof can be reduced and it can be produced at low cost. Further, only a small frictional force acts between convex portions and the inner wall face of the housing at the static state of the device and therefore, the device can easily be secured to other devices.

The rotary type damping device according to the present invention has such a structure detailed above and therefore, the device permits the efficient damping of the differential rotational movement generated between the housing and the flange member (the shaft body) and the quite stable damping. For this reason, this damping device can be fitted to a variety of industrial machinery and tools, in particular, to the rotating parts thereof and accordingly, the damping device of the invention can be used in wide variety of fields as, for instance, door closer dampers; rear suspension dampers for bicycles (such as two-wheeled vehicles); opening and closing dampers for doors or leaves, or covers or lids for machinery and tools for office automation (OA devices), furniture or the like, which can be opened and closed; dampers for collapsible or foldable chairs; and dampers for reclining seats.

In particular, favorably used bicycles are those provided with light weight bodies irrespective of whether they are those used for competition or those for popular use and therefore, it is quite preferable to use such a light-weight damping device like that according to the present invention.

Furthermore, according to the rotary type damping device of the present invention, the damping ability thereof can be controlled by changing the press contact force acting between the housing and the convex portions formed on the flange member. Accordingly, the flange member can, if necessary, be compressed to thus increase the press contact force acting between the convex portions and the housing by, for instance, preparing the flange member from an elastic material such as a rubber material to thus give, to the device, a mechanism for controlling the compressive force in the axial direction which permits the compression and release or relaxation in the axial direction. Thus, there can be provided a damping mechanism whose damping force or ability can easily be adjusted.

In the case where the foregoing structure is used as the rear suspension damper for a bicycle or the like, the damping device can be incorporated into the rear swing arm and the rotating shaft portion of the body to thus realize a rear suspension mechanism which is light-weight, but can arbitrarily control the damping characteristics upon the ascending and descending behaviors (rotational motions at the rotating shaft portion) of the rear wheel.

In addition, the rotary type damping device according to the present invention may be miniaturized because of its light-weight characteristics and its simplified structure and therefore, it is quite favorable for use as a damper in the rotating mechanisms for opening and closing members of, for instance, doors or covers. In particular, when at least the convex portions are made of a self-lubricating rubber material (such as an elastomer), the resulting damping device never requires the use of any grease and therefore, the damping device of this type is quite favorably used in, for instance, the OA machinery and tools and medical appliances.

### BRIEF DESCRIPTION OF THE DRAWINGS

FIG. 1 is a cross sectional view schematically illustrating an example of the structure of a direct acting type damping device according to a first embodiment of the present invention;

FIG. 2 shows the flange members used in the damping device showed in FIG. 1, wherein FIG. 2(a) is a cross sectional view thereof, and FIG. 2(b) is a top plan view of the same;

FIG. 3 is a diagram for explaining the operational state of the damping device as shown in FIG. 1, wherein FIG. 3(a) shows the device in the static state, FIG. 3(b) shows the device moving towards the direction A and FIG. 3(c) shows the device moving towards the direction B in which the peripheral face of the flange member is in a press contact state with the inner wall surface of the housing;

FIG. 4 shows schematic cross sectional views illustrating a variety of preferred variations of the flange member used in the direct acting damping device according to the present invention, wherein FIG. 4(a) shows a flange member which is tapered at various angles of inclination, FIG. 4(b) shows a flange member which is so tapered as to have a desired curvature, FIG. 4(c) shows a flange member which has notches on the tapered portion thereof, FIG. 4(d) shows an integral type flange member, FIG. 4(e) shows a plurality of flange members wherein a washer is arranged between each pair of neighboring flange members, FIG. 4(f) shows a flange member in a state wherein it is fitted to a piston rod through a sleeve and FIG. 4(g) shows a flange member in which slits are formed on the tapered portion thereof;

FIG. 5 is a load curve observed for the direct acting damping device of the present invention, which relates to the relationship between loads and displacing characteristics, as determined while maintaining the vibrational velocity at a constant level;

FIG. 6 is a load curve observed for the direct acting damping device of the present invention, which relates to the relationship between loads and displacing characteristics, as determined while variously changing the oscillation frequency;

FIG. 7 is a schematic perspective view for explaining the flange member used in the rotary type damping device according to a second embodiment of the present invention;

FIG. 8 is a diagram schematically showing the structure of the rotary type damping device according to the present invention, in which FIG. 8(a) is a truncated side view for illustrating the interior of the housing and FIG. 8(b) is a cross sectional view taken along the line A-A shown in FIG. 8(a);

FIG. 9 is a diagram schematically showing the structure of the rotary type damping device according to the present invention, in which FIG. 9(a) is a truncated side view for illustrating the interior of the housing and FIG. 9(b) is a cross sectional view taken along the line A-A shown in FIG. 9(a);

FIG. 10 is a transverse sectional view showing a variety of shapes of the flange member used in the rotary type damping device according to the present invention, in which FIG. 10(a) is a transverse sectional view showing a flange member provided with steps, FIG. 10(b) is a transverse sectional view showing an integral type flange member provided with steps, FIG. 10(c) is a transverse sectional view showing a step-free type flange member and FIG. 10(d) is a transverse sectional view showing a stepped type flange member in which the tips of the convex portions are further tapered in the axial directions;

FIG. 11 is a schematic diagram showing a different variations concerning the convex portions of the flange member used in the rotary type damping device according to the present invention, wherein FIG. 11(a) is a schematic diagram showing a convex portion tapered at different angles of inclination, FIG. 11(b) is a schematic diagram showing a convex portion so tapered as to have a desired curvature, FIG. 11(c) is a schematic diagram showing a convex portion having notches on the tapered portion thereof, FIG. 11(d) is a schematic diagram showing an integral type convex portion, FIG. 11(e) is a schematic diagram showing a plurality of convex portions wherein a washer is arranged between each pair of neighboring convex portions, FIG. 11(f) is a schematic diagram showing a convex portion in a state wherein it is fitted to a shaft body through a sleeve and FIG. 11(g) is a schematic diagram showing a convex portion in which slits are formed on the tapered portion thereof;

FIG. 12 is a diagram showing a sample of the rotary type damping device according to the present invention used in quality test thereof, in which FIG. 12(a) is a truncated side view for illustrating the interior of the housing of the device and FIG. 12(b) is a cross sectional view taken along the line A-A shown in FIG. 12(a); and

FIG. 13 is a graph showing torsion torque-torsional amplitude characteristics as determined using the test sample as shown in FIG. 12 while variously changing the frequency.

### BEST MODE FOR CARRYING OUT THE INVENTION

An example of the direct acting type damping device or damper according to the first embodiment of the present invention will hereunder be described in more detail with reference to the drawings attached hereto.

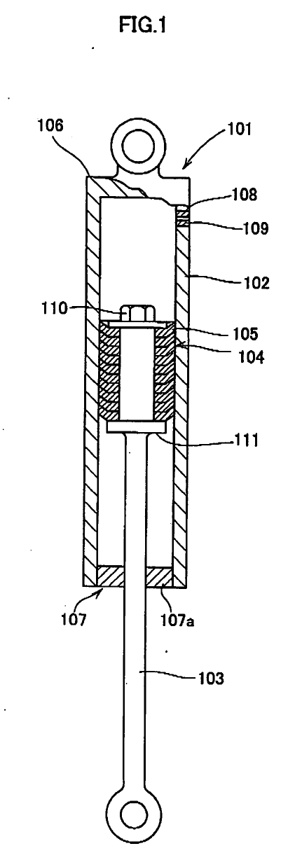

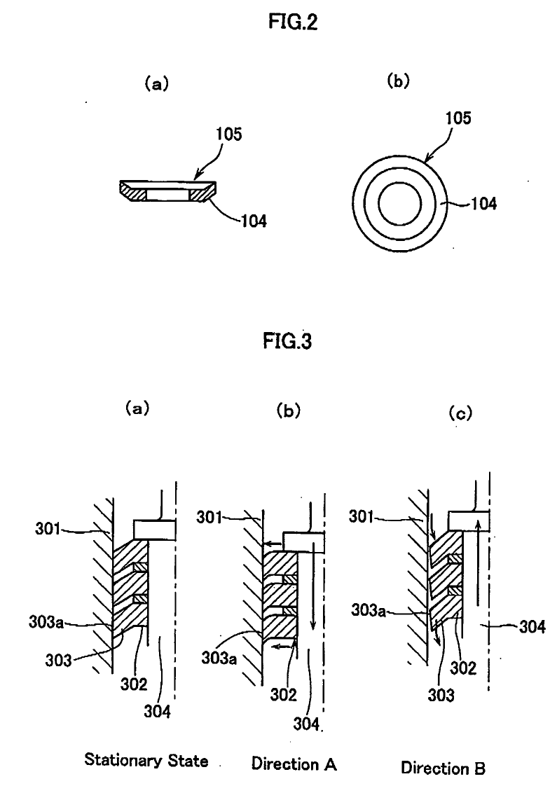

FIG. 1 is a schematic cross sectional view showing the direct acting type damping device according to the present invention; FIG. 2 shows cross sectional views of the flange member used in this damping device; and FIG. 3 is a constitutional diagram for explaining the operations of the damping device.

As will be seen from FIG. 1, this damping device is a direct acting type damping device 101 which comprises a cylindrical housing 102, a piston rod 103 undergoing reciprocating motions within the housing and a flange member 104 as a disk-like damping or braking member. This flange member, in its free state, has an outer diameter slightly greater than the inner diameter of the housing to which it is fitted. Further the flange member is unidirectionally tapered, towards the periphery thereof, at portions on both sides thereof opposed to one another and apart from the center of the same. The peripheral side face of the flange member 104 is engaged with the inner wall face of the housing while the former is slightly pressed against the latter. In FIG. 1, the reference numeral 105 represents the tapered portion of the flange member 104.

In the housing 102, one end along the axial direction of the device is a closed end 106 and the other end of the device is an open end 107. The open end 107 is tightly closed by a washer 107a consisting of a known hard plastic material such as a fluorocarbon resin. In addition, an orifice 108 is formed in the proximity to the closed end 106 so that, when the space on the side of the closed end 106 is compressed by the movement of the piston rod 103, the air present in the space may externally escape from the interior of the housing. Alternatively, it is also possible to dispose a valve member 109 in the vicinity of the closed end 106 and this would permit not only the damping by the flange member 104, but also the damping by the air.

In this connection, grease may be applied onto the friction and/or sliding surface between the foregoing flange member 104 and the housing 106. As such grease, there may be used, for instance, a product obtained by mixing fluorine atom-containing resin type grease with molybdenum disulfide. The use of such grease would permit the control of the device so that any wear of the flange member 104 can be reduced or suppressed and that the device can show an appropriate frictional force.

The flange member 104 comprises a plurality of pieces and it is so designed that at least two pieces are fitted to the piston rod 103 in such a manner that the inclined faces or tapered portions 105 of these pieces are put on top of each other and that they are fastened with a bolt 110 and thus fitted to the piston rod. The flange member 104 may be fitted to the device through the use of a sleeve or without using any sleeve. In FIG. 1, the reference numeral 111 represents a piston head. The flange member 104 may be prepared from an elastomer such as a known synthetic rubber material or an elastomeric plastic material and more specifically, the flange member may be prepared from, for instance, a naturally occurring rubber material or acrylonitrile-butadiene rubber.

Moreover, the rubber material usable herein may be, for instance, a self-lubricating rubber material which comprises base rubber and an externally migrating type internal lubricating agent (hereunder referred to as “a lubricating agent having a bleeding ability”) incorporated therein and bled from the base rubber when it is practically used to thus impart lubricating characteristics to the rubber.

The shape of the flange member 104 used in the damping device as shown in FIG. 1 is not restricted to any specific one insofar as it has unidirectionally inclined tapered area 105 as shown in FIGS. 2(a) and 2(b). A variety of variations of the flange member will be detailed below.

When putting the foregoing damping device in operation, the engaged (or press contact) conditions of the inner wall face of the housing and the peripheral side face of the flange member are in the relationships as shown in FIGS. 3(a) to 3(c).

As will be seen from FIG. 3(a), the inner wall face of the housing 301 is engaged with the peripheral side face 303a or the end face of the flange member 302 in such a manner that the former is slightly pressed against the latter, in a stationary state. For this reason, the flange member 302 having tapered portions 303 has a diameter slightly greater than the inner diameter of the housing 301 so that the inner wall face of the body is in a slightly press contact condition with the peripheral side face of the flange member in assembling the damping device. In this figure, the reference numeral 304 represents a piston rod.

When switching from the static state to a moving stage or the stage of moving towards the direction A (upon contraction) as shown in FIG. 3(b), the relative movement of the peripheral side face 303a of the flange member 302 having tapered portions and the inner wall face of the housing 301 is interrupted due to the frictional force acting between the peripheral side face of the flange member and the inner wall face of the housing to thus stop a desired movement. The peripheral side face 303a of the flange member goes up to a level almost identical to that of the body of the flange member other than the tapered portions due to the movement of the piston rod 304. The ascent of the peripheral side face 303a may lead to the generation of a repulsive force towards the radial direction of the flange member 302 so that the peripheral side face of the flange member is further strongly pressed against the inner wall face of the housing 301. Thus, a stronger frictional force is generated and this would in turn permit the more efficient damping of a desired movement.

In addition, when moving towards the direction B (upon elongation) as shown in FIG. 3(c), the flange member 302 having tapered portions 303 may easily undergo deflection in the tapered direction, any press contact force is not generated and therefore, any friction and hence any damping is not generated.

As has been discussed above in detail, the direct acting type damping device according to the present invention is so designed that the part thereof apart from the center of the flange member is formed into a unidirectionally inclined shape and that the damping force is changed between the outward or going stroke and the return stroke of the piston rod due to the difference in the rigidity originated from the difference in the shape. In other words, the mechanism of generating the damping force used in the present invention is quite differs from that employed in the invention disclosed in the foregoing prior art (TOKUHYO Hei 11-5112269). More specifically, this conventional technique requires the use of a supporting plate and the generation of the highest press contact force at the stationary state. On the other hand, the present invention never requires the use of any supporting plate and the press contact force observed during the operation in one direction of the piston rod is quite higher than that observed during the operation in the other direction thereof. In this respect, however, it is a matter of course that the higher the press contact force, the higher the generated friction and the higher the resulting damping effect. As has been described above, the damping device of this invention considerably differs in the damping force between the contracting or shrinking direction and the elongating direction and therefore, it can be used in a variety of fields and applications. In addition, the foregoing flange member 302 may be so designed that it comprises a plurality of pieces and that they are tapered at the same angle of inclination on the corresponding faces, as discussed above. In this case, the axial length thereof can be reduced even when a large number of such pieces are put on top of each other. Thus, a compact damping device can be produced and accordingly, the device of the present invention can thus be used in further wide variety of fields.

In the direct acting type damping device according to the present invention, the flange member having tapered portions may be fitted to the piston rod through a sleeve likewise engaged with the piston rod or may directly be engaged with the piston rod without using any sleeve. In the case of the damping devices free of any sleeve, if the flange member is fastened while it is pressed in the axial direction, the diameter thereof is increased due to the deformation of the resilient body. Accordingly, the press contact force acting between the flange and the inner wall face of the housing further increases and thus the frictional force and hence the damping force can be changed or controlled. Moreover, the damping device according to the present invention may be provided with a remote control mechanism to thus externally control the damping force even after the assemblage of the device. As an example of such a remote control mechanism, there may be listed a mechanism in which the flange member is pressed in the axial direction from the outside. The use of such a mechanism would permit the control of the press contact force or the damping force acting between the device and an outer or outward cylindrical member.

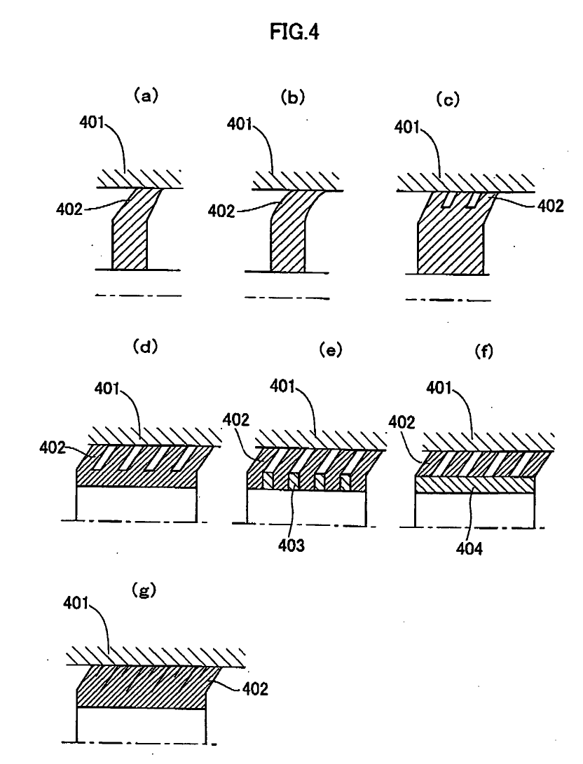

The shape of the flange member usable in the direct acting damping device according to the present invention is not restricted to any specific one inasmuch as the flange member has a tapered structure as has been described above and a number of variations of the flange member preferably used herein are shown in FIGS. 4(a) to 4(g) as cross sectional views thereof. In these figures, the reference numerals 401, 402, 403 and 404 represent a housing, the tapered portion of a flange member, a plate and a sleeve, respectively.

FIG. 4(a) shows a flange member having tapered portions on the both sides thereof such that the angles of inclination of these tapered portions are different from one another unlike those shown in FIG. 2 in which the angles of inclination are identical to one another; FIG. 4(b) shows a flange member provided with, on the both sides of the member, tapered portions 402 whose taper has a desired curvature; FIG. 4(c) shows a flange member provided with taper on every corresponding sides of the tip thereof and having at least one notch (or cut) on the tapered portion 402; FIG. 4(d) shows an integral type flange member; FIG. 4(e) shows a flange member comprising a plurality of pieces wherein each piece has a structure similar to that of the flange member provided with tapered portions on every corresponding sides thereof as shown in FIG. 2, plates 403 consisting of, for instance, a hard plastic material are arranged between each neighboring pieces except for the tapered portions thereof as washers and they are preferably firmly fixed; FIG. 4(f) shows a flange member in a state wherein it is fitted to a piston rod through a sleeve 404 and FIG. 4(g) shows a flange member provided with tapered portions on every corresponding sides thereof, in which slits (notches) having desired shapes are formed on the tapered portion 402 thereof. When using washers like the embodiment as shown in FIG. 4(e), the outer diameter of these washers should be selected in such a manner that the deformation of the flange is not regulated depending on the sliding directions of the flange. Moreover, when grease is used for the sliding faces, the notches as shown in FIG. 4(c) and the slits as shown in FIG. 4(g) may likewise function as reservoirs for the grease.

Incidentally, the peripheral side face of the foregoing flange member is brought into contact with the inner wall face of the housing.

As has been described above, the direct acting damping device according to the present invention is so designed that it can show the damping characteristics in the contraction direction greater than those observed in the elongation direction. The damping characteristics of the device may arbitrarily vary depending on various factors such as the number of pieces constituting a flange member, the thickness thereof, the material therefor, the tapering degree and shape of the tapered portion on the flange member and the rate of the tapered portion relative to the other portion of the flange member. Accordingly, a desired damping device can be provided by appropriately selecting and/or designing these parameters while taking into consideration the kinds of industrial machinery and tools to which the damping device is applied.

Then a test sample of the direct acting type damping device according to the present invention was produced according to the following procedures and the test sample thus produced was put on a universal vibration testing system to thus determine the load-displacement characteristics observed when the sample was put into reciprocating motions at a constant vibration frequency.

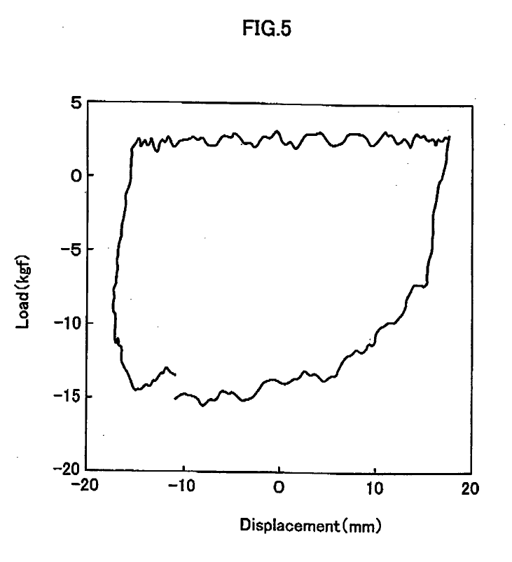

A naturally occurring rubber material was vulcanized and molded into a disk-like body having an outer diameter of 26.3 mm and a thickness of 3 mm and having a taper whose stating point was 10 mm apart from the center and which had an angle of inclination of 35 degrees to thus give a flange member having a rubber hardness of A65/S (as determined using JIS K6253 A Type Durometer). Three flange members thus prepared were put in layers alternate with washers each having an outer diameter of 20 mm and a thickness of 0.8 mm, the resulting assembly was fitted to the tip of a piston rod with nuts, the grease prepared by mixing fluorine atom-containing resin type grease and molybdenum disulfide was applied onto the sliding portions of the foregoing flange members and then this assembly was inserted into a cylindrical housing having an inner diameter of 25.8 mm to thus give or assemble a test sample. This test sample was put on the universal vibration testing system followed by putting the sample into reciprocating motions at a frequency of 2 Hz±20 mm at room temperature to thus determine the load-displacement characteristics of the sample. The results thus obtained are plotted on FIG. 5.

As will be seen from the data plotted on FIG. 5, in the direct acting type damping device according to the present invention, the damping force in the sliding direction B (in the smaller damping direction) is about 5 times smaller than that observed in the sliding direction A (in the greater damping direction).

In the foregoing test sample, washers are incorporated into the same through lamination, but the washers never serve to regulate the deformation of the flange member depending on the sliding directions since the outer diameters of the washers are smaller than the outer diameters of the flange members. Therefore, it is clear that there is a definite difference in the damping force depending on the directions.

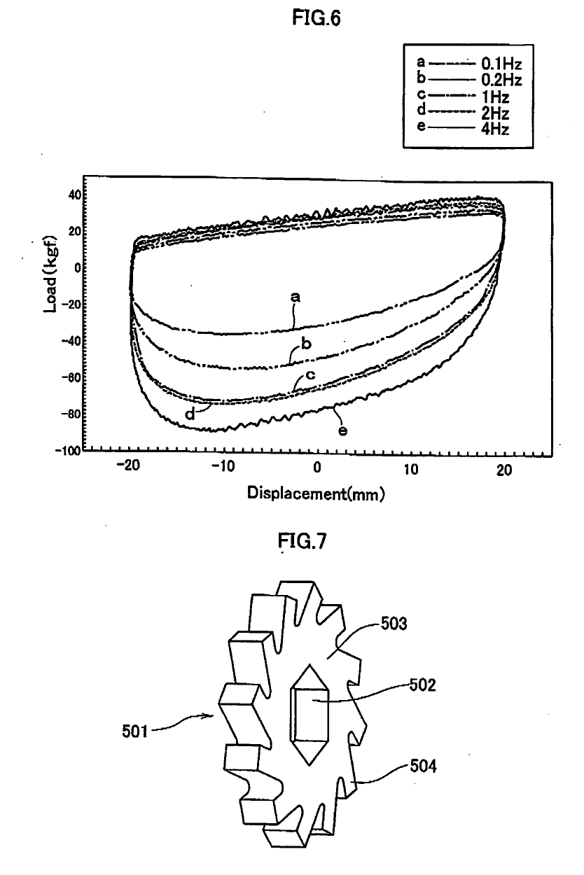

Then the same procedures used above for the preparation of the foregoing test sample were repeated except that 13 flange members and a desired number of washers were used and that a coil spring having a spring constant of 6.6 N/mm (0.67 kgf/mm) is provided between the tip of a piston rod and the bottom of a cylindrical housing to thus form a test sample. The resulting test sample was put on the universal vibration testing system to thus determine the load-displacement characteristics of the sample while variously setting the vibration frequency at 0.1 Hz, 0.2 Hz, 1 Hz, 2 Hz and 4 Hz. The results thus obtained are plotted on FIG. 6.

As will be seen from the data plotted on FIG. 6, in the direct acting type damping device according to the present invention, it was found that the load increased as a function of the vibration frequency in the sliding direction A or the load in this sliding direction was dependent on the vibration frequency. On the contrary, the load did not show any dependency on the vibration frequency in the sliding direction B.

Therefore, it is clear that the direct acting type damping device according to the present invention not only shows clear difference in the damping characteristics in the reciprocating motions, but also shows such characteristic properties that it can generate a strong damping force against an instantaneously applied load (or an impactive load) and it can generate a weak damping force against a slowly applied load.

The characteristic properties described above are quite favorable for the damping device such as a suspension.

Then, an example of the rotary acting type damping device according to the second embodiment of the present invention will hereunder be described in more detail with reference to the drawings attached hereto.

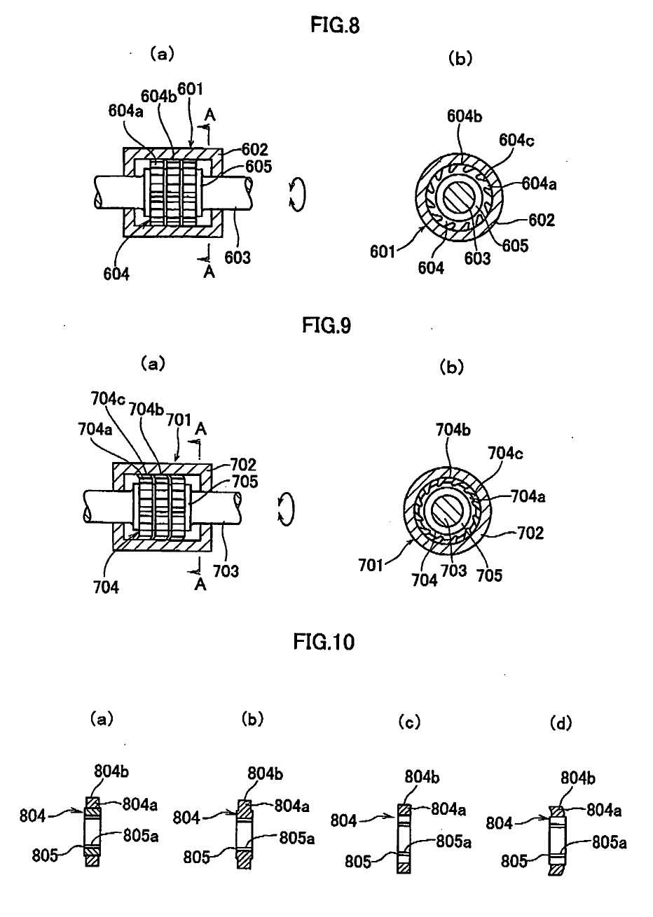

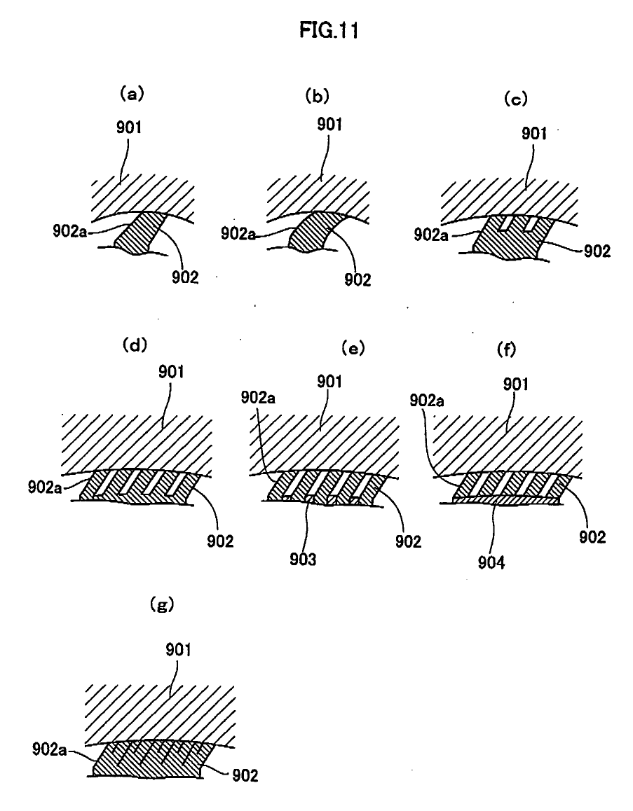

FIG. 7 is a schematic perspective view for explaining a disk-like flange member for damping used in the rotary type damping device according to the present invention; FIGS. 8 and 9 are schematic truncated side views (FIGS. 8(a) and 9(a)) and cross sectional views each taken along the line A-A shown in FIG. 8(a) or 9(a) for schematically showing the structure of the rotary type damping device according to the present invention, respectively (FIGS. 8(b) and 9(b)); FIG. 10 is a transverse sectional view showing a variety of shapes of the flange member used in the rotary type damping device according to the present invention; and FIG. 11 is a schematic diagram showing a different variations concerning the convex portions of the flange member used in the rotary type damping device according to the present invention.

As shown in FIG. 7, the flange member 501 comprises an engaging member 503 having an engaging portion 502 arranged at the axial center of the flange member. The flange member is provided with convex portions 504 at the outer periphery of the engaging member and the convex portions are formed in such a manner that they are inclined with respect to the radial direction of the rotation axis.

FIG. 7 shows an embodiment of the flange member 501 in which both of the engaging member and the convex portions are integrally molded or formed from the same material consisting of a resilient material such as rubber or an elastomer. These engaging member and convex portions may be integrally molded from the same material or may be integrally molded from different materials. Moreover, the engaging member and the convex portions are separately formed and they are then adhered to one another. In this respect, it would be sufficient that this engaging member may be prepared from, for instance, a metallic material, a plastic material, a rubber material or an elastomeric material, while the convex portions may be prepared from a resilient material such as a rubber material or an elastomeric material. This rubber material of course includes a self-lubricating rubber material which comprises base rubber and a lubricating agent having a bleeding ability, which is incorporated in the base rubber and bled from the base rubber when it is practically used to thus impart lubricating characteristics to the rubber.

The self-lubricating rubber material which may be used in the damping device of the present invention will now detailed below.

The base rubber material used in the self-lubricating rubber material is not restricted to any specific one, but preferably used herein are rubber materials excellent in the vibration proof characteristics (such as naturally-occurring rubber materials), those excellent in the wear-resistant characteristics (such as acrylonitrile-butadiene rubber) or a blend of these materials. Specific examples thereof include natural rubber, acrylonitrile-butadiene rubber, hydrogenated acrylonitrile-butadiene rubber, ethylene-propylene-diene terpolymer rubber, various kinds of fluorine atom-containing rubber materials and acrylic rubber materials. These materials may appropriately be selected and blended with one another depending on applications (specifications) and the compatibility with a lubricating agent having a bleeding ability (hereunder simply referred to as “bleeding lubricant”) as will be detailed later. Such a bleeding lubricant is not restricted to any particular one insofar as it can impart a desired self-lubricating function to the base rubber and it can show a desired function upon its practical use and specific examples thereof are a variety of oil products such as silicone oil and modified silicone oil; waxes such as paraffin waxes; fatty acids and fatty acid salts; and aliphatic substances such as aliphatic amides. In the foregoing discussion, rubber is taken as a specific example, but the present invention is not restricted to rubber at all and the base material may likewise be, for instance, an elastomer inasmuch as it can satisfy the requirements for the desired functions.

A specific example of such a self-lubricating rubber material preferably comprises a bleeding lubricant in an amount ranging from about 1.5 parts by mass to 10 parts by mass per 100 parts by mass of the base rubber. This is because if the amount of the bleeding lubricant incorporated into the same is less than 1.5 parts by mass, there may be such a tendency that the resulting self-lubricating rubber material would results in an insufficient extent of bleeding upon the use thereof, while the use of the bleeding lubricant in an amount of higher than 10 parts by mass would be apt to result in an excess of bleeding and to thus result in a considerable reduction of the processability. If the quantity of bleeding is too high, it would be difficult to obtain a desired torque and the bleeding lubricant may be liable to be exhausted within a short period of time. Accordingly, the amount thereof to be incorporated should appropriately be selected while taking into consideration each particular application of the resulting device.

In addition, the foregoing base rubber material may be prepared by appropriately incorporating, into the same, various additives such as a vulcanizing agent, a vulcanization accelerator, an auxiliary agent for vulcanization, a processing aid, a reinforcing agent, a softening agent, an antioxidant (an age-resistant agent), and/or a tackifier. Specific examples of vulcanizing agents include sulfur, organic peroxides, oximes, alkyl phenol resins, disulfides, metal oxides and/or polyamines and these vulcanizing agents are practically selected and used depending on the kinds of rubber materials selected. Examples of vulcanization accelerators used in combination with the vulcanizing agents are sulfenamide type ones, thiazole type ones, thiuram type ones, dithiocarbamic acid salts, xanthogenic acid salts and thiourea, which may be used alone or in any combination of at least two of them. As such an auxiliary agent for vulcanization, generally used may be, for instance, zinc oxide. Examples of processing aids usable herein fatty acids such as stearic acid, and/or fatty acid derivatives. Examples of reinforcing agents suitably used herein in general include carbon black and silica. Examples of softening agents in general include process oil products such as paraffin type ones, naphthene type ones and aromatic ones. As the foregoing antioxidants and tackifiers, there may be used, for instance, those currently known ones.

The foregoing bleeding lubricant employed in the self-lubricating damper rubber used in the present invention may preferably be, for instance, at least one member selected from the group consisting of, for instance, aliphatic amides such as stearic acid amide, palmitic acid amide, oleic acid amide, erucic acid amide and lauric acid amide. As has been discussed above, the use of an aliphatic acid amide as such a bleeding lubricant would permit the achievement of stable bleeding characteristics and therefore, the device of the present invention permits the maintenance of the desired self-lubricating properties over a long period of time.

As has been shown in FIGS. 8(a) and 8(b), the rotary type damping device 601 according to the present invention is equipped with a cylindrical housing 602, a shaft body 603 arranged within the housing in a freely rotatable manner and a flange member 604 as a disk-like member for damping which is fitted to the shaft body. In this figure, the flange member is secured to a sleeve 605 and it is then fixed to the shaft body through the sleeve, but the flange member may likewise directly be fitted to the shaft body without requiring any interposition of a sleeve. When it is fixed to the shaft body through a sleeve, the sleeve is so designed that it has unevenness on the inner wall surface, which can engage with the unevenness on the surface of the shaft body (not shown) and that the shaft body can thus rotate together with the flange member (the sleeve). In this respect, however, it would be preferred to engage the sleeve with the shaft body in a size which permits the interstitial engagement of these members when it is intended to design the device in such a manner that the sleeve can be removed from the shaft body.

This sleeve 605 is, for instance, provided with a flange member 604 made of rubber vulcanized and adhered to the outer periphery of the sleeve and the sleeve is thus a basic part of the flange member which is engaged with and fixed to the shaft body 603. This sleeve has a disk-like shape and is provided with, at the center, such an engaging portion required for being engaged or fitted with and fixed to the shaft body, but the inner diameter and the shape of the inner wall surface is not restricted to any specific one. Thus, it is sufficient that the sleeve can engage with the shaft body and the flange member can thus rotate together with the shaft body. It would be sufficient in the invention that such shapes are preferably a shape with key way, a gear-like shape, a width across flat, a polygonal shape (such as a tetragonal shape, a pentagonal shape and a hexagonal shape) and a spline-like shape. In this case, the shape of the outer surface of the shaft body is so designed that the shape is in good agreement with that of the inner surface or the inner diameter of the sleeve. Alternatively, if it is not necessary to remove the sleeve from the shaft body, these two members may be engaged through the use of a stationary-fit or close-fit type engagement.

As has been described above, the use of a sleeve 605 is not always necessary and both of the flange member 604 and the sleeve may be prepared from a resilient material depending on the magnitude of the load applied to the device.

In this embodiment, the sleeve 605 is secured to the shaft body 603 by the engagement while making use of the unevenness of the surfaces thereof, but the sleeve and the flange member 604 are usually adhered or fixed to one another by vulcanizing and molding a rubber material on the outer periphery of the sleeve made of, for instance, a metal as has been described above or these members are adhered to one another simultaneous with the formation of the flange member. This adhesion method is not restricted to any particular one insofar as it allows the adhesion of the flange member to the sleeve. For instance, when preparing the flange member from a thermoplastic elastomer, these members may be adhered to one another simultaneous with the formation of the flange member by injection molding the flange member on the outer periphery of the sleeve provided with hooking portions. In this case, it is not necessary to use any adhesion.

The flange member 604 has, in its free state, an outer diameter slightly greater than the inner diameter of the housing 602 assembled with the same. The flange member is so designed that the outer periphery face 604b of the tips of the projected portions 604a formed on the outer periphery of the flange member is pressed against the inner wall surface of the housing and that the projected portions pressed against the inner wall surface of the housing are formed in such a manner that they are inclined with respect to the radial direction of the shaft body 603 at a desired angle. In the flange member, at least the projected portions thereof are made of a resilient material.

As has been described above, the projected portions 604a (such as blades made of rubber), which are pressed against the inner wall surface of the housing 603, are formed in such a manner that they are inclined with respect to the radial direction of the shaft body 603. Therefore, when the housing undergoes relative rotational motions in the direction opposite to the radial direction of the projected portions (in the inclination direction) with respect to the flange member 604 which can rotate in response to the rotation of the shaft body, the projected portions prop against the inner wall surface of the housing due to the rotation resistance (rolling resistance or frictional force) generated between the outer peripheral faces 604a of the tips of the projected portions and the inner wall surface of the housing and therefore, damping of rotation is caused between the flange member and the housing. In this case, a force from the inner wall surface of the housing in the press-contact state with the same is applied to the projected portions in the direction of compression and accordingly, a proper frictional force can be obtained even in the presence of grease as will be detailed below between the projected portions and the inner wall surface of the housing and the presence of such grease would permit the inhibition of any wear.

On the other hand, when the housing 602 undergoes relative rotational motions in the direction identical to the radial direction of the projected portions 604a with respect to the flange member 604 which can rotate in response to the rotation of the shaft body 603, the outer peripheral faces 604b of the tips of the projected portions do not resist against the inner wall surface of the housing and the projected portions are rather inclined in response to the rotational motions. Accordingly, any rotational resistance would hardly generate between the outer peripheral faces of the tips and the inner wall surface of the housing and as a result, almost no damping of rotation is caused between the flange member and the housing.

Therefore, in the rotary type damping device according to the present invention, the rotational damping force can arbitrarily be changed depending on the rotational directions and the applications of the device can thus be greatly expanded.

In the damping device according to the present invention, it is sufficient to design the housing 602 in such a manner that the flange member 604 (and the shaft body 603) can be arranged within the body in a freely rotatable state and therefore, the both ends thereof in the axial direction may be opened or closed or either one of them may be closed. When the housing has a closed end, the shaft body is secured to the side wall of the housing using, for instance, a washer made of a known hard plastic material such as a fluorocarbon resin and the housing is sealed. In this respect, however, it is sufficient in the rotary type damping device according to the present invention that the seal is a simple one unlike the liquid-tight seal type device. In other words, it would be sufficient that the seal prevents any penetration of, for instance, dust having a large size, motes as well as water.

Grease may be applied onto the friction-sliding surface between the outer peripheral faces 604b of the tips of the projected portions 604a and the inner wall surface of the housing. The grease of this type may appropriately be selected while taking into consideration various factors such as the kinds of materials used for preparing the projected portions, the estimated endurance limits and the magnitude of loads applied. The use of the grease would permit the inhibition of any wear of the flange member, in particular, the projected portions, the generation of a proper frictional force and hence the improvement of the endurance.

Three pieces of such flange members 604 fixed to the sleeve 605 are put on top of one another as shown in FIG. 8 while making, for instance, the directions of the inclined parts 604c of the projected portions uniform and they are then engaged with a shaft body 603 having such an outer peripheral surface adapted to the internal shape or the inner diameter of the foregoing sleeve and fastened with, for instance, a bolt to thus adhere the flange body to the shaft body through the sleeve. In this embodiment, a flange member obtained by putting three pieces on top of each other is taken by way of example for the convenience of the explanation, but the number of pieces is not restricted to any specific one and the flange member may, if necessary, comprise only one such piece or a combination of at least two such pieces.

As has been described above, in the embodiment shown in FIG. 8, the flange member 604 may likewise be attached to the shaft body through the sleeve 605 or directly without using any sleeve and it would be sufficient that at least the projected portions 604a of the flange member 604 may be prepared from an elastomer such as a known synthetic rubber material or an elastomeric plastic material and it is a matter of course that they may be prepared using a naturally occurring rubber material.

As shown in FIG. 7, the foregoing flange member 604 may be one provided with, on the outer periphery thereof, integrally molded projections (convex portions) which are inclined with respect to the radial direction of the rotary shaft. And the shape and the method for the preparation thereof are not restricted to specific ones at all, inasmuch as they do not interfere with the achievement of the desired objects. Various kinds of variations concerning the flange members provided with convex portions will be described later in detail.

Moreover, as shown in FIGS. 9(a) and 9(b), the rotary type damping device 701 according to the present invention comprises, for instance, a housing 702, a shaft body 703 and a sleeve 705 which are the same components used in the embodiment as shown in FIG. 8, but the device comprises a disk-like flange member 704 for damping which has a shape different from that of the flange member used in the embodiment shown in FIG. 8. The flange member is so designed that the tip outer periphery 704b of the convex portions 604a are pressed against the inner wall surface of the housing and it is provided with, on the edges of these convex portions (for instance, blade-like portions made of a rubber material), tapered portions or areas 704c which are inclined towards the axial direction. In this case, the device would permit the generation of a difference in the damping force depending on the direct acting directions (right and left directions in FIG. 9(a)).

Although there is not depicted in any figure, the rotary damping device according to a still further embodiment of the present invention comprises a shaft body provided with a compressive force-regulating mechanism so that a compressive force is applied to a flange member for damping arranged within a housing in the axial direction. In this case, the flange member can be fastened while applying a compressive force to the same in the axial direction and accordingly, the damping force can likewise be controlled even after the incorporation of the flange member into the damping device by making the flange member deform in the peripheral direction. In this case, it is preferred that the flange member completely comprises a rubber material.

In an embodiment, for instance, an axial direction compression mechanism (such as a screw) is provided in advance and the mechanism is properly adjusted when the device is interrupted. In the simplest case of this embodiment, the shaft body is provided with a screwing-in mechanism such as a screw, but this mechanism is not fixed to the housing. In addition, such an axial direction compression mechanism (such as a screw) is secured to the housing so that it is screwed in when the differential angle with respect to the housing increases. Thus, in this embodiment, the damping force may vary depending on the angles between them. In this case, for instance, a screw member is arranged on the housing side, while threads capable of being engaged with the same are formed on the movable shaft body.

The following are the examinations of the contact or engaging state between the inner wall surface of the housing and the outer tip peripheral faces of the projected portions on the flange member observed when operating the rotary type damping device according to the present invention.

The foregoing rotary type damping device 601, 701 is assembled in such a manner that the inner wall surface of the housing 602, 702 is brought into contact with, in its stationary state, the outer tip peripheral faces 604b, 704b of the projected portions 604a, 704a on the flange member 604, 704 in a slightly press-contact condition and accordingly, the outer diameter of the flange member having the inclined projected portions is slightly greater than the inner diameter of the housing.

In the rotary type damping devices 601 and 701 as shown in FIGS. 8 and 9, the projected portions 604a and 704a are formed so that they are inclined and therefore, when the box-like bodies 602 and 702 undergo relative rotational motions in the direction opposite to the radial direction of the projected portions, the projected portions prop against the inner wall surfaces of the box-like bodies due to the rotation resistance (rolling resistance) generated between the tip outer peripheral faces 604b and 704b of the projected portions and the inner wall surfaces of the box-like bodies. As a result, a repulsive force is generated in the radial direction of the projected portions, the outer tip peripheral faces of the projected portions are in turn more strongly pressed against the inner wall surface of the housing to thus generate a stronger rotation resistance. Thus, the damping of rotation is caused between the flange member and the housing. On the other hand, when the housing undergoes relative rotational motions in the direction identical to the radial direction of the inclined projected portions, the tip outer peripheral faces of the projected portions do not resist against the inner wall surface of the housing and the projected portions are rather bent in response to the rotational motions and inclined towards the rotational direction. Accordingly, any rotational resistance would hardly generate between them and as a result, almost no damping of rotation is caused between the flange member and the housing.

The rotary type damping device according to the present invention in which the damping force may greatly be dependent upon the rotational direction can be used for a wide variety of applications in a variety of fields as has been discussed above in detail. Moreover, if a flange member has tapers of the same angle of inclination on the faces opposed to one another like the flange member described above, the length of the shaft can be reduced even when using a number of such flange member put on top of one another to thus miniaturize the damping device. As a result, the fields of applications of the damping device of the invention can further be expanded.

As has been described above, in the rotary type damping device according to the present invention, the flange member having projected portions may be fixed to the shaft body through a sleeve or it may directly be secured to the shaft body without interposition of any sleeve. In the case of the damping device free of any sleeve, if the flange member is fastened in a state in which it is pressed in the axial direction, its diameter increases due to the deformation of, for instance, a resilient body to thus increase the press-contact force thereof against the inner wall surface of the housing and accordingly, the frictional force and hence the rotational damping force can be changed. In addition, when the flange member is completely prepared from a rubber material, the means for fitting the flange member to the shaft body may likewise include a means in which the flange member is directly vulcanized on the shaft body to thus adhere the same to the body. Furthermore, the device may be provided with a remote controlling mechanism so that the damping force may be adjusted even after the assemblage of the device from the outside. As an example of such a remote controlling mechanism, there may be listed, for instance, one in which the flange member is compressed in the axial direction from the outside as has been discussed above. Such a mechanism would permit the control of the press-contact force with respect to the external cylindrical member or the damping force.

The flange members which may be used in the rotary type damping device according to the present invention are not restricted to particular ones inasmuch as they are provided with projected portions having an angle of inclination, as discussed above. A variety of preferred variations of this flange member are shown in FIGS. 10(a) to 10(d).

FIG. 10(a) shows a disk-like flange member 804 for damping provided with convex portions 804a (whose outer tip peripheral face is represented by the reference numeral 804b) formed on the flange member at an angle of inclination in the radial direction of the rotational axis. This flange member is adhered or secured to the shaft body made of, for instance, a metal or a resin through a sleeve 805 (an engaging member) and is a stepped type one in which the thickness of the convex portions is thinner than that of the portions other than the convex portions. This stepped type flange member means one which is so designed that, when fitting a plurality of such members to the shaft body, every neighboring convex portions (such as blade-like portions made of rubber) in the axial direction may form a gap between them. If there are such gaps between them, they can absorb any volume change due to the deformation of the convex portions compressed when the convex portions prop against the housing. Thus, any torque generated can be controlled by appropriately selecting the angle of inclination of the convex portions with respect to the direction of the rotational axis and/or the height of the convex portions. In addition, the inner shape of the engaging portion 805a of the sleeve may be, for instance, shapes described above such as a shape with a key way, a gear-like shape or a hexagonal shape, while the shape of the outer surface of the shaft body is one capable of being well-engaged with the shape of the engaging portion. In this case, a sleeve may be present between the flange member and the shaft body or any sleeve is not present between them.

FIG. 10(b) shows a disk-like flange member 804 for damping which has a similarity in appearance to the flange member described above in connection with FIG. 10(a). This flange member is the same as that of FIG. 10(a) except that it is a stepped type one, made of rubber material, in which the convex portions 804a is integral with the portions other than the convex portions in such a manner that the thickness of the former is thinner than that of the latter.

FIG. 10(c) shows another variation of the disk-like flange member for damping. In this case, the flange member 804 is secured to the shaft body made of a metal or a resin through a sleeve 805 and the projected portions 804a made of a rubber material of the flange member has a thickness identical to that of the portions other than the projected ones. When fitting a plurality of such flange members to the shaft body, spacers are inserted between every neighboring two flange members. More specifically, when alternatively arranging these flange members and spacers, a gap may be formed between each neighboring two flange members or between each neighboring two projected or convex portions. This flange member has such an advantage that its shape is simpler than those of the other parts or members. The flange member may completely be prepared from a rubber material. As for the others, they are the same as those described above in connection with FIG. 10(a).

FIG. 10(d) shows an embodiment of the flange member 804 which has projected portions 804a provided with tapered areas on the tip portions thereof in the axial direction. This flange member corresponds to a stepped flange member adhered to the shaft body made of a metal or a resin through a sleeve 805. The use of such a flange member would permit the establishment of a difference in the degree of damping depending on, in particular, the direct acting directions. As for the others, they are the same as those described above in connection with FIG. 10(a).

The shapes of the flange member provided with the projected portions are not restricted to those described above and the flange member may have any other shape insofar as it would permit the achievement of the desired objects of the present invention.

Moreover, when using a plurality of such flange members in combination, they may comprise those having the same shapes or they may be those having different shapes. For instance, in the rotary type damping device as shown in FIG. 8, flange members may be used in combination, which have projected portions different in the inclination directions and/or the angles of inclination. When using, in combination, flange members provided with projected portions different in, for instance, the inclination directions, the damping force can, if necessary, be adjusted depending on the forward/backward rotational directions with respect to the relative rotational motions of the housing and the flange member which can rotate in response to the rotation of the shaft body. This is quite favorable when using the same in the suspension of, for instance, bicycles since the damping force thereof can be controlled on the elongation side and the compression side.

Alternatively, it is also possible to use a flange member whose projected portions partially have opposite inclination directions and in this case, a damping difference is generated in the rotational directions depending on the rate of the projected portions having different inclination directions. This embodiment is effective in the cases wherein desired rotational damping is required in the both forward and backward rotational directions.

Further, when using a plurality of flange members provided with projected portions each having a large angle of inclination, a strong rotational damping force can be established by a smaller number of flange members. In this case, the resulting damping device may have a compact size.

As has been discussed above, the rotational damping force of the device can be controlled by adjusting a variety of factors such as the number of flange members used, and the inclination directions and the angle of inclination of the projected portions. Moreover, if the device is equipped with the compressive force-regulating mechanism as has been discussed above, the damping force can likewise appropriately be controlled even after the assemblage of the damping device.

The projected portions on the flange member may have a variety of shapes as shown in FIGS. 11(a) to 11(g). FIG. 11 shows a state of the damping device in which the tip outer peripheral faces of the projected portions are in press-contact state with the inner wall surface of the housing. These FIGS. 11(a) to 11(g) correspond to the FIGS. 4(a) to 4(g), respectively.

More specifically, FIG. 11(a) shows a projected portion 902 of the flange member having tapered parts 902a which are present on the corresponding both sides of the projected portion and have different angles of inclination. In this case, the flange member is brought into close contact with the inner wall face of the housing 901. FIG. 11(b) shows a projected portion 902 having tapered parts 902a on every faces, which have a desired curvature. FIG. 11(c) shows a convex or projected portion 902 of the flange member having tapered parts 902a which are present on the corresponding both sides of the projected portion and each of which is provided with at least one notch (or cut). FIG. 11(d) shows an integral type convex portion 902 having a plurality of tapered parts 902a. FIG. 11(e) shows a plurality of convex or projected portions spaced apart from one another and having tapered parts 902a present on the corresponding both sides of each projected portion, wherein plate 903 made of, for instance, a hard plastic material and serving as a washer is arranged between each pair of neighboring convex portions except for the tapered parts thereof and firmly fixed thereto. FIG. 11(f) shows convex portions 902 provided with tapered parts 902a, which are in such states that they are fitted to a shaft body through a sleeve 904. FIG. 11(g) shows a convex portion 902 having tapered parts 902a which are present on the corresponding both sides of the portion and in which desired slits (or cuts) are formed on the tapered parts thereof. When using a washer as shown in FIG. 11(e), the washer should be so designed that the outer diameter thereof never regulates any deformation of the projected portion depending on the sliding directions. Moreover, when using grease on the sliding surface, the notches shown in FIG. 11(c) and the slits shown in FIG. 11(g) described above may likewise serve as a reservoir for the grease.

As has been described above, the rotary type damping device according to the present invention is so designed that it can generate rotational damping between the housing and the flange member which can rotate in response to the rotation of the shaft body, with respect to the relative rotational motions of these members. The damping characteristics may arbitrarily be changed depending on various kinds of factors such as the number and thickness of the flange members, the materials therefor, the tapering angle and shape of the projected portions on the flange member and the ratio of the projected portions of the flange to the other parts of the flange. Therefore, any desired damping device can be provided by appropriately selecting and establishing these parameters while taking into consideration the kinds of industrial machinery and tools to which the damping device is applied.

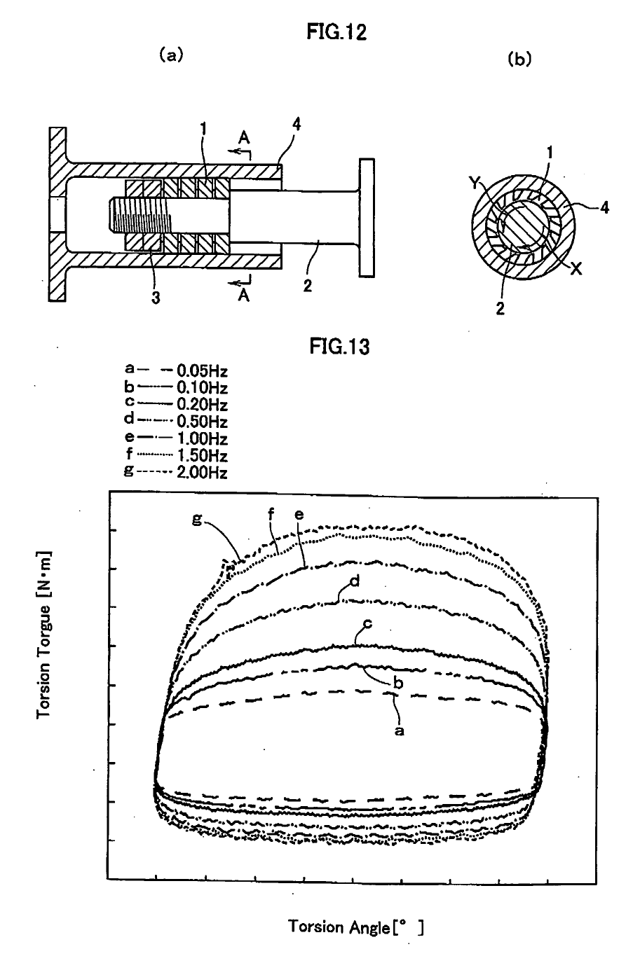

Then there was produced a test sample of the rotary type damping device having a structure shown in FIG. 12, the resulting test sample was set on a torsional vibration-testing machine to thus determine the torsional torque-torsional amplitude characteristics of the sample observed when the sample was put in rotational motions at a constant vibrational frequency. FIG. 12(a) is a truncated side view for illustrating the interior of the housing of the damping device and FIG. 12(b) is a cross sectional view taken along the line A-A shown in FIG. 12(a).

Naturally occurring rubber material was vulcanized and molded into a disk-shaped flange member 1 having a structure as shown in FIG. 12, an outer diameter of 26.6 mm (as determined at its free length state); a thickness of 5 mm (as determined at its free length state); a thickness of the tapered part (projected portion) of 3 mm (as determined at its free length state); the taper-initiating point (as determined at its free length state) situating at 10 mm apart from the rotational center; and an angle of taper (as determined at its free length state) of 30 degrees and having a rubber hardness of A65/S (as determined using JIS K6253 Model A Durometer). Four such flange members were set on a shaft body 2, the tip of the shaft body was fastened with a nut 3, grease comprising fluorine atom-containing resin type grease and molybdenum disulfide incorporated therein was applied onto the sliding portion of the foregoing flange members and the resulting assembly was inserted into and engaged with a cylindrical housing 4 having an inner diameter of 25.8 mm to thus give a test sample. The resulting test sample was set on the torsional vibration-testing machine to thus determine the torsional torque-torsional amplitude characteristics of the sample observed when the sample was put in rotational motions under the following conditions: a torsional amplitude of ±40 degrees and various test frequencies of 0.05, 0.10, 0.20, 0.50, 1.00, 1.50 and 2.00 Hz. The results thus obtained are plotted on FIG. 13.

In FIG. 13, curves indicated by symbols a, b, c, d, e, f and g correspond to torsional torque-torsional amplitude characteristics curves observed when the test frequencies were set at 0.05 Hz, 0.10 Hz, 0.20 Hz, 0.50 Hz, 1.00 Hz, 1.50 Hz and 2.00 Hz, respectively.

As will be seen from the data plotted on FIG. 13, the rotary damping device according to the present invention can generate a high torsional torque ranging from 1.0 to 3.2 Nm in proportional to the angular velocity (test frequency) when the device is put in torsional and rotational reciprocating motions at a torsional amplitude of ±40 degrees and during the forward rotational motions (rotational motions on the high torque side: the rotational motions along the direction of the X-axis on FIG. 12), while it can generate only a small torsional torque ranging from −0.5 to −1.0 Nm, although it may slightly be changed proportional to the changes in the angular velocity (test frequency) when the device is put in the backward rotational motions (rotational motions on the low torque side: the rotational motions along the direction of the Y-axis on FIG. 12) and the range of the variation thereof is likewise narrow. In other words, the damping device of the present invention has a large difference in the rotational torque between the forward and backward rotational motions and has torsional torques showing the rotational angular velocity-dependency only during the forward rotational motions.

Such characteristic properties of the damping device described above are quite favorable for the rotary type damping device used in industrial machinery and tools, in particular, those in which the rotational angle of the rotatable parts such as a shaft is never beyond 360 degrees and which undergo reciprocating motions. It is a matter of course that the device can be used as a damping device for rotating mechanisms after converting linear motions of vibrating bodies into rotational motions using, for instance, a link mechanism or a rack and pinion gear and the applications thereof are not restricted to rotational motions whose rotational angle is not more than 360 degrees at all.

### INDUSTRIAL APPLICABILITY

As has been described above in detail, the damping device according to the present invention is favorable, in particular as damping mechanisms which should satisfy the requirements for the miniaturization, lightness and easy handling ability and it can thus be used, for instance, in the following applications:

(1) Dampers for suspensions used in, for instance, automobiles and dump trucks as well as dampers for hatch backs and sliding doors;

(2) Dampers for front and rear suspensions of bicycles, in particular, those used for competition;

(3) Rotary dampers applied to chairs for OA machinery and tools and those used in theaters; and

(4) Dampers used for opening and closing the doors of OA machinery and tools; and the damping device can satisfactorily show its functions.

1. A damping device comprising a housing and a flange member for damping arranged in the housing, wherein at least portions of the flange member apart from a center thereof are composed of an elastic material and inclined with respect to an axial direction or a radial direction of a rotational axis and wherein the flange member is so designed that a peripheral face thereof is brought into contact with an inner wall of the housing.

2. The damping device as set forth in claim 1, wherein at least the portions of the flange member, which are brought into contact with the inner wall of the housing, are produced from a self-lubricating rubber material.

3. The damping device as set forth in claim 1, wherein the damping device is a direct acting type one and wherein the device is so designed that the device comprises the housing, a piston rod capable of undergoing reciprocating motions within the housing and the flange member for damping made of an elastic material and fitted to the piston rod, that the flange member is tapered towards peripheral edges on its both sides opposed to one another and that the peripheral face of the flange member is thus pressed against the inner wall of the housing.

4. The damping device as set forth in claim 3, wherein the flange member has such an outer diameter that the inner wall of the housing is pressed against the peripheral face of the flange member, at the static state of the piston rod, and these members are thus in a press contact condition.

5. The damping device as set forth in claim 3, wherein the flange member is characterized in that a part thereof apart from its center is formed into a unidirectionally inclined shape.

6. The damping device as set forth in claim 3, wherein the flange member is secured to the piston rod in such a manner that, when the piston rod at its stationary position moves within the housing along and towards a direction A or towards one end of an axial direction, the peripheral face of the flange member is stopped with respect to the inner wall face of the housing due to an action of frictional force generated between these faces to thus inhibit a movement thereof towards the direction A and to thus cause desired damping.

7. The damping device as set forth in claim 3, wherein the flange member is secured to the piston rod in such a manner that, when the piston rod at its static state moves within the housing along and towards a direction B or an end of an axial direction opposite to a direction A, any press contact force is not generated due to any deflection of the flange member and, in its turn, any damping is not generated.

8. The damping device as set forth in claim 3, wherein the flange member is secured to the piston rod in such a manner that, when the piston rod at its stationary position moves within the housing along and towards a direction A or towards one end of an axial direction, the peripheral face of the flange member is stopped with respect to the inner wall face of the housing due to an action of frictional force generated between these faces to thus inhibit a movement thereof towards the direction A and to thus cause desired damping and that, when the piston rod at its static state moves within the housing along and towards a direction B or an end of an axial direction opposite to the direction A, any press contact force is not generated due to any deflection of the flange member and, in its turn, any damping is not generated.

9. The direct acting type damping device claim 3, wherein the device is attached to front suspensions for bicycles.

10. The damping device as set forth in claim 1, wherein the damping device is a rotary damping type one, the rotary damping device comprises a housing secured to one outward member and a flange member for damping which is so arranged that it is rotatable within the housing and has an engaging portion allowing the engagement with a shaft body fixed to an another outward member so that differential rotary movements of these two outward members can be damped, wherein the flange member comprises an engaging member allowing the engagement with the shaft body, the engaging member is provided with convex portions made of an elastic material on an outer periphery thereof, and the convex portions are so designed that the portions are inclined with respect to a radial direction of a rotary shaft and pressed against the inner wall face of the housing.

11. The damping device as set forth in claim 10, wherein the flange member is characterized in that the engaging member and the convex portions are integrally molded.

12. The damping device as set forth in claim 10, wherein the housing and the flange member are so arranged that the housing generates rotational resistance with respect to the flange member when the housing rotates relative to the flange member in a direction opposite to a radial direction of the inclined convex portions formed on the flange member to thus damp the differential rotary movements generated between the housing and the flange member.

13. The damping device as set forth in claim 10, wherein the housing and the flange member are so arranged as to generate rotational resistance lower than that generated in a direction opposite to a radial direction of the inclined convex portions formed on the flange member when the housing rotates relative to the flange member in a direction identical to the radial direction.

14. The damping device as set forth in claim 10, wherein at least tips of the convex portions are formed on the flange member such that the portions are inclined with respect to an axial direction.

15. The damping device as set forth in claim 10, wherein the one outward member is a main body of a bicycle and the another outward member is a rear wheel-supporting member thereof or the one outward member is a rear wheel-supporting member of a bicycle and the another outward member is a main body thereof, and the rotary damping device is attached to a suspension of a bicycle.

16. The damping device as set forth in claim 10, wherein the device is attached to a rotating mechanism for an opening and closing member.

17. The direct acting type damping device as set forth in claim 6, wherein the device is attached to front suspensions for bicycles.

18. The direct acting type damping device as set forth in claim 7, wherein the device is attached to front suspensions for bicycles.

19. The damping device as set forth in claim 11, wherein the housing and the flange member are so arranged that the housing generates rotational resistance with respect to the flange member when the housing rotates relative to the flange member in a direction opposite to a radial direction of the inclined convex portions formed on the flange member to thus damp the differential rotary movements generated between the housing and the flange member.

20. The damping device as set forth in claim 11, wherein the housing and the flange member are so arranged as to generate rotational resistance lower than that generated in a direction opposite to a radial direction of the inclined convex portions formed on the flange member when the housing rotates relative to the flange member in a direction identical to the radial direction.

21. The damping device as set forth in claim 12, wherein the housing and the flange member are so arranged as to generate rotational resistance lower than that generated in a direction opposite to a radial direction of the inclined convex portions formed on the flange member when the housing rotates relative to the flange member in a direction identical to the radial direction.

22. The damping device as set forth in claim 11, wherein at least tips of the convex portions are formed on the flange member such that the portions are inclined with respect to an axial direction.

23. The damping device as set forth in claim 12, wherein at least tips of the convex portions are formed on the flange member such that the portions are inclined with respect to an axial direction.

24. The damping device as set forth in claim 13, wherein at least tips of the convex portions are formed on the flange member such that the portions are inclined with respect to an axial direction.

25. The damping device as set forth in claim 11, wherein the one outward member is a main body of a bicycle and the another outward member is a rear wheel-supporting member thereof or the one outward member is a rear wheel-supporting member of a bicycle and the another outward member is a main body thereof, and the rotary damping device is attached to a suspension of a bicycle.

26. The damping device as set forth in claim 12, wherein the one outward member is a main body of a bicycle and the another outward member is a rear wheel-supporting member thereof or the one outward member is a rear wheel-supporting member of a bicycle and the another outward member is a main body thereof, and the rotary damping device is attached to a suspension of a bicycle.

27. The damping device as set forth in claim 13, wherein the one outward member is a main body of a bicycle and the another outward member is a rear wheel-supporting member thereof or the one outward member is a rear wheel-supporting member of a bicycle and the another outward member is a main body thereof, and the rotary damping device is attached to a suspension of a bicycle.

28. The damping device as set forth in claim 14, wherein the one outward member is a main body of a bicycle and the another outward member is a rear wheel-supporting member thereof or the one outward member is a rear wheel-supporting member of a bicycle and the another outward member is a main body thereof, and the rotary damping device is attached to a suspension of a bicycle.

29. The damping device as set forth in claim 11, wherein the device is attached to a rotating mechanism for an opening and closing member.

30. The damping device as set forth in claim 12, wherein the device is attached to a rotating mechanism for an opening and closing member.

31. The damping device as set forth in claim 13, wherein the device is attached to a rotating mechanism for an opening and closing member.

32. The damping device as set forth in claim 14, wherein the device is attached to a rotating mechanism for an opening and closing member.

33. The damping device as set forth in claim 15, wherein the device is attached to a rotating mechanism for an opening and closing member.
